(19) United States
(12) Patent Application Publication
(10) Pub. No.: US 2015/0296843 A1
(43) Pub. Date: Oct. 22, 2015

(54) Coconut Cream Whipped Composition and Method for Making Same

(71) Applicant: Urszula Rojeck, Guelph (CA)

(72) Inventor: Urszula Rojeck, Guelph (CA)

(21) Appl. No.: 14/692,656

(22) Filed: Apr. 21, 2015

Related U.S. Application Data
(60) Provisional application No. 61/982,225, filed on Apr. 21, 2014.

(51) Int. Cl. A23L 1/00

(52) U.S. Cl. CPC A23L 1/0097

(57) ABSTRACT

Disclosed is an emulsion and method of making the same, wherein the emulsion includes: a fat component; at least one stabilizing agent. The fat component is from a coconut-based source. The emulsion is prepared by a method comprising: mixing the fat component and water to form a mixture; heating the mixture to about 60° C.; adding the stabilizing agent to the mixture; agitating the mixture; heating the mixture to about 60-65° C.; agitating the mixture for approximately 10 min; thermally treating the mixture by heating it to about 86° C., and then to at least about 123° C. for approximately 16 seconds; homogenizing the mixture at 1500 psi and about 72° C.; cooling the mixture.

### FIELD

This disclosure relates to a composition of, and process of preparing, coconut milk foam and whipped preparations with enhanced stability to be dispensed, for example, in containers or ready to use canisters.

### BACKGROUND

Whipped cream typically results as the product of continuous incorporation of air into liquid cream, resulting in an emulsion featuring the suspension of air in the liquid, which suspension is held stable by the presence of fat therein. A very common source of fat is cream from cow's milk or the like. In other instances, whipped products are created using various oils as the fat component thereof. Generally speaking, fat content, e.g., in excess of 20% by weight, is helpful, but not always necessary, in terms of making a stable foam.

While typically quite pleasing in terms of taste and texture, products derived from cow's milk in many whipped cream products raise considerations vis-à-vis the nutritional impact of consuming such a product. Further, product sensitivities and intolerances are a consideration for segments of the consumer population—e.g. lactose intolerant persons. Further, oil based products tend not to exhibit the favourable flavour and textural properties of cow's milk-based products.

Some known products have included milk fat or other vegetable fat, often including hydrogenated and partially hydrogenated oils, dairy or non-dairy proteins, and the like. Some of the difficulties in using any source of fat for mass produced whipped cream products are generally universal; however, the particular properties of any fat source may present specific difficulties, which has contributed to the failure to employ such sources in known compositions. By way of example, issues related to product oxidation may exist based on the level of unsaturation of the oil components of the particular fat source. More specifically, the high solid fat index of coconut cream at lower temperature and high concentration of saturated fats present difficulties with emulsion viscosity build up after processing, as well as over storage, in addition to sensitivity to temperature changes.

As such, efforts have been made to consider alternatives to these discussed fat sources whilst maintaining the advantageous properties such as texture, mouthfeel, taste, viscosity and stability. It is desirable to employ natural and/or organic sources of fat as these are nutritionally preferable and marketable to a large number of consumers.

### SUMMARY

There is disclosed herein a stable, high quality, palatable foam that may be used as a topping, or may be otherwise consumed, and may be provided, for example, in a ready to use, pressurized canister.

There is disclosed an emulsion comprising a fat component, and at least one stabilizing agent. The fat component is from a coconut-based source, and the emulsion is prepared by a method comprising the following steps: mixing the fat component and water to form a mixture; heating the mixture to about 60° C.; adding the stabilizing agent to the mixture; agitating the mixture; heating the mixture to about 65° C.; agitating the mixture for approximately 10 min; thermally treating the mixture by heating it to 86° C., and then to at least about 123° C. for at least 16 seconds; homogenizing the mixture at 1500 psi and about 72° C.; cooling the mixture.

In another disclosed aspect, coconut-based source comprises one or more of coconut cream, coconut milk, and creamed coconut.

In another disclosed aspect, the coconut-based source comprises coconut milk and the coconut milk is prepared from a powder.

In another disclosed aspect, the emulsion includes at least one sweetener, and is prepared by a method including a step of adding the sweetener to the mixture.

In another disclosed aspect, the emulsion has a total weight, and the fat component comprises 20 to 55% of the total weight, and the stabilizing agent comprises up to 1% of the total weight.

In another disclosed aspect, the sweetener comprises substantially 5 to 35% of the total weight.

In another disclosed aspect, a method of preparing an emulsion comprises: mixing a fat component and water to form a mixture; heating the mixture to about 60° C.; adding a stabilizing agent to the mixture; agitating the mixture; agitating the mixture for approximately 10 min; thermally treating the mixture by heating it to about 86° C., and then to at least 123° C. for at least 16 seconds; homogenizing the mixture at 1500 psi and about 72° C.; cooling the mixture.

In another disclosed aspect, the method includes the step of adding a sweetener to the mixture, while continuing to heat the mixture to about 65° C.

In another disclosed aspect, the method also includes providing the mixture in a canister adapted to whip the mixture into a whipped cream product, and fill with air at a concentration ranging from 120 to 145 ppm.

In another disclosed aspect, the fat component is a coconut-based component, and comprises one or more of coconut cream, coconut milk, and creamed coconut.

In another disclosed aspect, the coconut-based component comprises coconut cream

### DETAILED DESCRIPTION

The emulsion disclosed herein may comprise a fat component, from a coconut-based source. It also includes at least one stabilizing agent. The coconut-based source includes one or more of coconut cream, coconut milk, and creamed coconut (macerated coconut flesh). In embodiments where coconut milk is used, it may be prepared from a powder.

In some embodiments, and instead of or in combination with a raw coconut cream or milk, a coconut milk powder may be used. This is distinct from known processes wherein the milk-based, non-coconut source of fat is typically provided solely in liquid or paste form. The use of such a powder results in the product typically including more fiber. Rehydration of the powder will form a necessary component of any manufacturing processes including powder-based fat sources.

One or more sweeteners may be included in the emulsion. Examples include sugars such as, for example, dry sugar, high fructose corn syrup (“HFCS”) and glucose syrup . Alternative sweeteners such as, for example, honey or coconut sugar may be included in some embodiments. By way of example, alternative sweeteners and, for example, stevia-based products may be used in embodiments where a reduced sugar or lower calorie product is desired. Honey and similar products may be used in instances where there is a desire to have a natural or organic product, or to maximize the number of components with such traits. For example, coconut sugar, if a predominantly coconut based product. Maltodextrins or inulin may be used in some embodiments to increase solid content and soluble fiber of the product.

The precise proportions of the product will depend on the desired traits of the end product. Factors influencing this will include, for example, desired viscosity, the need for storage, the medium of provision to customers and the like.

The stabilizing agent will generally make up not more than about 1% of the total weight. Examples of stabilizers that may be used are mono and diglicerides, and κ-carrageenan. Others include but are not limited to xanthan gum, guar gum, polysorbate 60, polysorbate 80, and sodium steroyl lactylate, and microcrystalline cellulose. The concentration of the stabilizer will typically not exceed 1% of the emulsion (by weight). Certain stabilizers, e.g., mono and diglycerides, polysorbate 60 and 80, and sodium steroyl lactylate function as emulsifiers and serve to further stabilize the emulsion in the regard, and to ensure and control the optimal extent of partial coalescence of the mixture during storage. In choosing which emulsifiers, gums and/or surfactants may be employed in a given embodiment, it must be taken into account that certain ones of these protect the fat globules from agglomeration, reduce creaming process and viscosity build up over time. Further, they allow fat globules to partially agglomerate and entrap aerating gas during can pressure release. This determination is many respects a balancing act between favouring a stable emulsion and favouring a stable dispensed foam product (in embodiments provided in that manner).

The sweetener may make up substantially 5 to 35% of the total weight.

Stabilizing and emulsifying agents such as mono- and di-glycerides may make up approximately 0.6% of some embodiments. The concentrations of the particular stabilizing and/or emulsifying agents to be used will depend on their own properties as well as, among other things, the fat concentration of the particular mixture. iota-carrageenan may be provided in a concentration of approximately 0.06% of the mixture. Other gums may also be provided in the mixture (such as those described above), with a total concentration of approximately 1% of the total mixture.

Additional components such as flavouring and the like may be included, and the balance of the total weight will typically be water.

Looking to the steps involved in the manufacture of whipped products disclosed herein, in general terms, the various ingredients are homogenized to make an emulsion with a particle size around 10 micrometers, and a monodistributed size distribution with most particles below 30 micrometers. The emulsion mixture is cooled to refrigeration temperature, and then can be stored and packaged in a canister. The process may generally include mixing a coconut cream (or powder or creamed coconut) with at least one stabilizer, and one surfactant, and then sugar, to produce a stabilized cream; filling in a disposable pressurized canister; whipping the stabilized cream mixture to introduce air into the mixture (in some embodiments, aseptic filling may be used).

More specifically, a method of preparation of the emulsion first includes mixing the fat component and water (preferably at a temperature of about 40-45° C.) to form a mixture. The water may have previously been mixed with stabilizers such as cellulose gum and gel as the mixture circulates. Additional ingredients such as mono- and di-glycerides (about 0.6% by weight), iota carageenan and sugar may be added, and pumed with the water into a process tank. The fat component (e.g., coconut cream) may then be added, along with further addition of sugar. This step requires mixing two somewhat immiscible components with the goal of providing an oil and water emulsion in accordance with known methods of achieving this goal.

This mixture is then heated to about 60° C., as that temperature provides for more effective melting down of mono- and di-glycerides.

At various stages in the process, quality control measures and compensatory additions to the mixture may be made if properties are not within desired ranges (e.g., acceptable results of fat and total solids analyses at 60-63° C.

The heated mixture is then agitated. The mixture may, while agitating, be heated to about 60-65° C., and agitated for approximately 10 min. The mixture is then thermally treated by heating it to about 86° C., and then to at least 123° C. for at least approximately 16 seconds. Such treatment is aimed at exerting microbial control and providing for appropriate levels of food preservation properties. The mixture is then homogenized at approximately 1500 psi and at about 72° C. The mixture is then cooled to approximately 10° C. The prepared mixture is then packaged into sanitized cans and pressurized with propellants. These filled cans are then refrigerated so as to limit chances that the fat melted into the mixture will coalesce and diminish product quality and performance.

The process of preparation of the coconut milk and the formulation allows for a product with a refrigerated shelf life of at least 6 months. In some embodiments, additives such as vitamins (C and/or E) and/or rosemary extracts and the like, may be added both for health and nutritional purposes and for the ability of some such additives to increase shelf life to approximately 1 year.

An exemplary method by which an emulsion according to present disclosure may be prepared is summarized as follows: (a) Heating a mixture of coconut cream and water to 55-60° C.; (b) Adding cellulose gel, mono and diglycerides and carrageenan (or other suitable gums or proteins); (c) Agitating; (d) Continue heating mixture, adding corn syrup, sugar, and heating to 60-65° C.; (e) Mix for approximately 10 min; (f) Heat mixture to 86° C. and then to at least 123° C. for at least about 16s, for thermal treatment; (g) Homogenize mixture at 1500 psi and 72° C.; (h) Cool mixture to about 10° C.

Again, mixtures of this type may then be provided in canister (e.g., with appropriate preservatives and propellant agents) or other formats, as is known in the art.

Manipulations of the absolute and relative proportions of fat and sweetener contents of the product will alter its properties. Such properties include those readily discernible to consumers (e.g., texture, mouth foel, sweetness) and properties more apparent during manufacturing, storage and marketing procedures (eg., shelf life etc,). For example, higher fat concentrations will increase mouthfeel properties of the product and increased sugar concentrations will increase body and, of course, sweetness.

Whipped products disclosed herein may exhibit desirable texture and stability (e.g., no or low separation of components), creamy mouthfeel, and other characteristics similar to those of known, whipped creams produced based on cow's milk and the like.

A balance between small droplets and partially coalesced droplets within the mixture ensures optimal whipping properties. At sufficient concentration the mix is stable. Additional stabilizers may contribute to enhanced mouthfeel and stability of the end whipped product. Depending on concentration levels, these additional stabilizers may also enhance freezing stability of the product. At very low levels of mono and diglycerides, or polysorbate, the emulsions will not be stable and partial coalescence would not occur. These ingredients also displace some of the coconut protein from the interface, and allow for better whippability—so an optimal level is necessary for a good equilibrium between stable and partly stable droplets. In effect, there is a focus on achieving balance between stability of the emulsion and stability of any resultant, propelled foam.

Embodiments aimed at not including conventional dairy cream sources have required the use of added sources of oil or protein to achieve or even approximate the desirable whipped cream performance properties described herein. Embodiments disclosed herein require only coconut cream (be it from liquid or powder sources), without any added oil or protein, while still providing a mouthfeel and other properties close to those of freshly prepared whipped cream based on conventional fat sources (including, for example, viscosity and yield stress).

In some embodiments, flavoring and/or coloring agents may also be added.

In various embodiments, examples of fat sources could include: coconut cream (approximately 24% fat; 30% solids); coconut cream/milk powder (approximately 51%, protein 5% and carbohydrates 40%), and/or creamed coconut (approximately 79% fat and 97% solids).

In some embodiments, the composition of the whippable/whipped product may consist of approximately 37% solids and 13% fat. Ranges of concentrations for those components, while still achieving acceptable product performance, would be in the ranges of approximately 30-50% solids and 4-25% fat. For example, the composition of the whippable/whipped product may consist of approximately 54% coconut cream. Higher or lower concentrations could be employed whilst still achieving desired results, subject to the compensations discussed above vis-à-vis flavour and consistency (particularly with respect to use of powdered coconut milk).

In some embodiments, the composition of the whippable/whipped product may consist of approximately 13% corn syrup and approximately 13% HFCS. As is well known in the art, embodiments featuring lower concentrations of sugars, additional sweeteners, such as maltodextrins, may be added to reach a desired level of sweetness and texture. Ranges of concentrations for these components, while still achieving acceptable product performance, would be in the range of approximately 5-26% for HFCS and substantially 0-20% for corn syrup.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

All of the systems and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. An emulsion comprising:
a fat component;
at least one stabilizing agent;
wherein the fat component is from a coconut-based source, and
wherein the emulsion is prepared by a method comprising:
(a) mixing the fat component and water to form a mixture;
(b) heating the mixture to about 60° C.;
(c) adding the stabilizing agent to the mixture;
(d) agitating the mixture;
(e) heating the mixture to about 60-65° C.;
(f) agitating the mixture for approximately 10 min;
(g) thermally treating the mixture by heating it to about 86° C., and then to at least about 123° C. for at least approximately 16 seconds;
(h) homogenizing the mixture at 1500 psi and about 72° C.;
(i) cooling the mixture.

2. The emulsion of claim 1, wherein the coconut-based source comprises one or more of coconut cream, coconut milk, and creamed coconut.

3. The emulsion of claim 2, wherein the coconut-based source comprises coconut milk and the coconut milk is prepared from a powder.

4. The emulsion of claim 1, further comprising at least one sweetener, and wherein the emulsion is prepared by the method further comprising the steps of adding the sweetener to the mixture.

5. The emulsion of claim 1, wherein the emulsion has a total weight, and wherein:
the fat component comprises 20 to 55% of the total weight and the stabilizing agent comprises up to 1% of the total weight.

6. The emulsion of claim 5, wherein the sweetener comprises substantially 5 to 35% of the total weight.

7. A method of preparing an emulsion, the method comprising:
(a) mixing a fat component and water to form a mixture;
(b) heating the mixture to about 60° C.;
(c) adding a stabilizing agent to the mixture;
(d) agitating the mixture for approximately 10 min;
(e) thermally treating the mixture by heating it to about 86° C., and then to at least about 123° C. for at least approximately 16 seconds;
(f) homogenizing the mixture at 1500 psi and about 72° C.;
(g) cooling the mixture.

8. The method of claim 7, further comprising the step of, after step (c), adding a sweetener to the mixture, while continuing to heat the mixture to about 65° C.

9. The method of claim 7, further comprising the step of, after step (g), providing the mixture in a canister adapted to whip the mixture into a whipped cream product.

10. The method of claim 1, wherein the fat component is a coconut-based component, and comprises one or more of coconut cream, coconut milk, and creamed coconut.

11. The method of claim 10, wherein the coconut-based component comprises coconut milk and the coconut milk is prepared from a powder.

12. The method of claim 11, wherein the mixture has a total weight, and wherein:
the fat component comprises 20 to 55% of the total weight and the stabilizing agent comprises up to 1% of the total weight.

13. The method of claim 12, wherein the sweetener comprises substantially 5 to 35% of the total weight.
